(19) United States
(12) Patent Application Publication
(10) Pub. No.: US 2008/0314372 A1
(43) Pub. Date: Dec. 25, 2008

(54) Cable Slinger and Method of Use Thereof

(76) Inventors: John Guindon, Wawa (CA); Roger Guindon, Littleton, CO (US)

Correspondence Address: Leyendecker & Lemire, LLC, C/O PORTFOLIO IP, P.O. BOX 52050, MINNEAPOLIS, MN, 55402, US

(21) Appl. No.: 11/768,120

(22) Filed: Jun. 25, 2007

(51) Int. Cl. B60P 7/12; B61D 3/16

(52) U.S. Cl. 124/5; 410/47

(57) ABSTRACT

A cable slinging device comprising a sheath and a wrapper coupling mechanism wherein the device is adapted to enable a user to couple a wrapper to the coupling mechanism and subsequently release the wrapper during a throwing motion to move the wrapper from a first wrapper location to a second wrapper location.

### FIELD OF THE INVENTION

This invention generally relates to truck wrapper gripping devices.

### BACKGROUND

Logging is a process which involves felling (cutting down) trees, usually as part of a timber harvest. Timber is typically harvested to supply raw material for the wood products industry—including logs for sawmills and pulp wood for the pulp & paper industry. However, logging may also be performed to remove trees for forest management goals.

Loggers work with heavy, cumbersome tools such as chainsaws and other heavy equipment on uneven and sometimes unstable terrain, dealing with severe environmental conditions in the process. Inclement weather such as severe heat or cold is not uncommon. Unfortunately, injuries to loggers occur frequently—oftentimes the injury occurring far from a professional emergency treatment center. However risks experienced by loggers can be somewhat reduced by the use of mechanical tree harvesters, forwarders, and other safety devices.

In most instances the felled tress must be transported from the cut site to a mill or other location. Oftentimes, logging roads are used to transport the trees and are constructed to provide access to the forest. The roads are usually narrow, winding, and unpaved, although main haul roads may be wider, straighter and may be paved.

Driving logging rigs along the roads is a dangerous part of the logging operation. Loggers and drivers must ensure the logging load is properly secured to the truck bed or risk losing the load and causing extensive damage to the truck and other property as well as injury to themselves or others. In many instances, logging regulations and the design of the logging road help reduce damage and injuries by requiring a logger to appropriately wrap the logging truck prior to transporting the logs on the truck.

Logging truck load wrapping entails securing the logs to the bed of a logging truck; typically through the use of steel or synthetic cables. Chains may also be used. The wrappers may be placed around the logs by placing the logs on the wrapper and securing one end of the cable to the other cable end, as well as to the truck bed. In another wrapping method, the logs are first placed on the truck and then one or both wrapper ends are coupled over the logs and coupled to a section of the truck such as the truck frame. The wrappers may be secured to the truck with wenches, chains, hooks, or other coupling mechanisms.

Often, the act of positioning one end of the wrapper from one side of the truck bed, over the top of the log load, to the other side of the bed requires throwing the cable over the load. Many logging truck loads reach heights 14 feet tall and are placed on trucks 10.5 feet wide. Throwing heavy and cumbersome steel or even some of the lighter synthetic wrappers around the entire load is difficult, especially in inclement weather conditions. Additionally, there is a possibility that the cable may fall back upon a logger, potentially causing sever injury. Other injuries may occur to a logger's back, arms, or shoulders through the handling of the wrappers, especially when throwing a cable from one truck side to another. Loggers may be injured through careless handling of wrappers when loggers are tired from wrapping trucks. Unfortunately, there is a dearth of items on the market to help with placing the cable from one side of the truck and load to the other side of the load.

### SUMMARY OF THE DRAWINGS

FIG. 1A is an isometric view of a cable slinger in an extended position according to one embodiment of the invention.

FIG. 1B is an isometric view of a cable slinger in a receded position according to one embodiment of the invention.

FIG. 2A is an isometric view of a cable slinger rod portion and a tether line wrapper coupling mechanism according to one embodiment of the invention.

FIG. 2B is an isometric view of a cable slinger rod portion and strap wrapper coupling mechanism according to one embodiment of the invention.

FIG. 2C is an isometric view of a cable slinger rod portion and chain/cable wrapper coupling mechanism according to one embodiment of the invention.

FIG. 3 is a side view of a portion of a cable slinger having a cut-away section of a sheath and a slider.

FIG. 4A is an isometric view of a portion of a cable slinger showing a hook attachment device and a pin uncoupled from a cable slinger rod.

FIG. 4B is an isometric view of a portion of a rod and of a slider having a flange alignment portion.

FIG. 5 is an isometric view of a person coupling a cable slinger to a wrapper.

FIG. 6 is an isometric view of a person slinging a wrapper over a loaded truck with a cable slinger.

FIG. 7 is a top view of a portion of a chain wrapper and a portion of a coupled cable slinger.

FIG. 8 is an isometric view of a cable slinger without a rod and a screwably attached coupling mechanism.

### DETAILED DESCRIPTION

One embodiment of the invention is a cable slinger comprised of a sheath and a wrapper coupling mechanism. The cable slinger may also be comprised of a rod. An embodiment's sheath may be adapted to cover at least a portion of the rod with the rod adapted to slide into and out of the sheath. One version's wrapper coupling mechanism may be comprised a hook. The coupling mechanism may be coupled to a rod end or, in a non-rod version, to a sheath end. In one embodiment, the wrapper coupling mechanism may be coupled to a rod distal end. One embodiment's rod extends outwardly from a sheath open end, ending in the rod distal end. A rod longitudinal axis may be substantially parallel with a sheath longitudinal axis.

In one version, a logger may use the cable slinger to help the logger throw a wrapper end over a loaded logging truck bed, helping relieve stress on a logger's body and thereby decreasing injuries associate with logging truck wrapping. In one embodiment, a cable slinger may be stored, possibly in a logging truck cab, with the rod at least partially inserted into the sheath, coupling to the sheath at a first position and having a portion of the rod extending out of the sheath open end. The rod may be coupled to the sheath at the first position during times other than storage of the rod as well. The first position may be a retracted position. In one retracted position a rod proximal end is coupled to the sheath proximate a sheath closed end. One rod may couple to the sheath through the use of one or more ball-spring mechanisms coupled to the rod and inserted into sheath bores.

In one method of using a wrapper to stabilize a logging truck load, an embodiment's rod may be slid from the first position to a second position. In one second position, a greater portion of the rod may extend out of the sheath than extends out of the sheath in the first position. Once the rod is in a second position, in one method the coupling mechanism may be used to operatively couple the cable slinger to the wrapper. In methods not comprising cable slingers having a rod, there is not need to extend the embodiment to a second position. In either method, a person may hold onto the sheath and couple the coupling mechanism to a wrapper proximal end. The wrapper may be a chain and the coupling mechanism used may be a hook-type device.

At this point, in one method, the person may perform a “casting” motion with the cable slinger and coupled wrapper. One method's casting motion may include a person facing away from the truck, moving cable slinger backwards over the person's head, releasing the wrapper towards and over the truck. Other casting motions are also contemplated. In one method, it is at about the apex of the casting motion that the wrapper is released from the cable slinger. This may occur through utilizing a wrapper coupling mechanism adapted to slide the wrapper off at about the throwing motion apex. The method may also include performing a “jerking” motion near the apex to release the wrapper.

Upon being released from the cable slinger, in one method, the wrapper end travels from the side of the loaded logging truck that the person is on, over the top of the load, and landing on the ground on an opposing side of the truck. Using a cable slinger increases the likelihood that a logger is able to toss the wrapper over the load. Therefore, the likelihood that a wrapper will land on top of the load or fall back on the logger during logging load wrapping is decreased. Additionally, it is easier for a logger to wrap a load of logs with a wrapper such as, but not limited to, steel or synthetic cables as it may require less effort to place a wrapper from one side of the truck bed to the other side of the truck bed using a cable slinger than not using a cable slinger.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “wrapper” as used in this specification and the appended claims refers to a stabilization device adapted to encircle a portion of a mass or load, possibly for transportation or storage on a truck.

### One Embodiment of a Cable Slinger

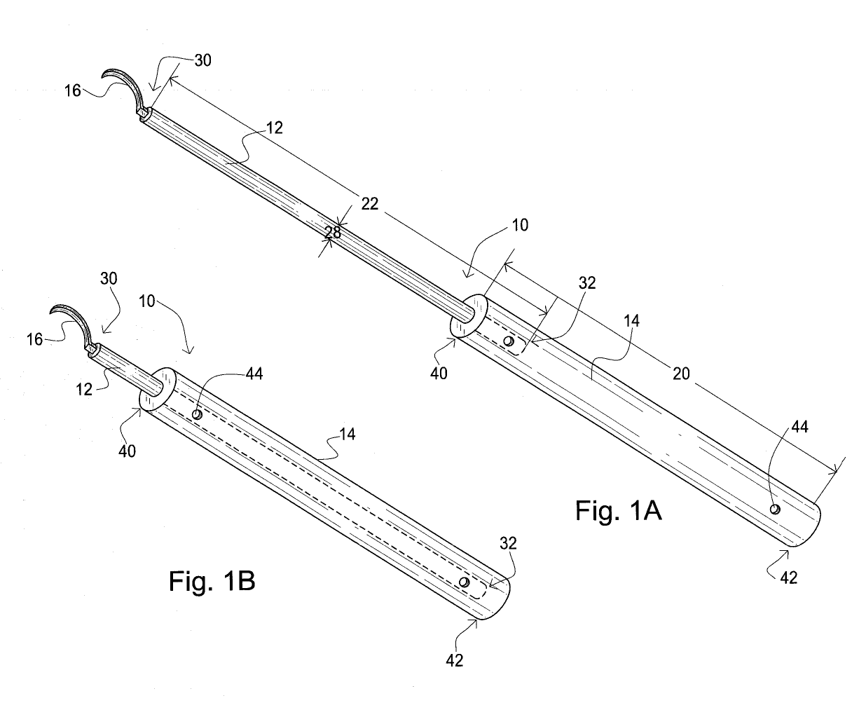

As best shown in FIGS. 1A through 4B, one embodiment of a cable slinger 10 is comprised of a rod 12, a sheath 14, and a wrapper coupling mechanism 16. One cable slinger may also be comprised of an inner slider 18. The wrapper coupling mechanism may also be referred to as a clasping mechanism or simply a hook. The wrapper coupling mechanism may be adapted to couple the slinger to wrappers such as, but not to cables, chains, and straps.

As best shown in FIG. 1A, in one embodiment, the length 20 of the sheath 14 may be about 2½ feet and the length 22 of the rod 12 may be about 3 feet. As best shown in FIG. 3, the length 24 of the inner slider 18 in one embodiment may be about 6 inches. One embodiment's sheath may have a general cylindrical shape, with a generally circular cross-sectional geometry. The sheath outer diameter 26 may be about ⅞ inches, although other embodiments having different diameters are contemplated. In particular, sheath diameters are preferably from ½ inch to 2 inches, more preferably from about ¾ to 1.5 inches, and most preferably from about ¾ to 1 inch. Similarly, the length of an embodiment's sheath where the sheath is adapted to couple to a rod is preferably from two to three feet in length, more preferably from 2¼ feet to 2¾ feet in length, and most preferably from 2 and 5/12 to 2 and 7/12 feet in length. Embodiments that do not include a rod have longer sheaths, with one embodiment having a sheath length about 5½ feet.

In one embodiment, the rod 12 may also have a general cylindrical shape. Also, one rod may have a generally circular or a generally oval cross-sectional area. However the cross section of the sheath or the rod may not be circular or oval. For example, the cross sectional geometry may generally be rectangular. One rod having a generally circular cross-sectional geometry may have a diameter of about ½ an inch. Other diameters or cross-sectional lengths of the rod and slider are also contemplated. For example, the rod may only have a diameter of about 0.375 inches, but may also have a diameter of about 1 inch in one embodiment, or any diameter in-between.

The rod 12 may be comprised of a distal end 30 and a proximal end 32. Similarly, the sheath may be comprised of a distal end 40 and a proximal end 42. The sheath's distal end may also be referred to as the open end since the distal end may have an opening allowing the rod to slide in and out of the sheath. The sheath proximal end may the sheath closed end. In a non-rod embodiment, the distal end may also be a closed end. One sheath opening may be created by a washer coupling to the distal end of a sheath such as, but not limited to, a pipe or a fiberglass broom handle.

In one embodiment, the rod 12 may have a longitudinal axis substantially parallelly aligned with a sheath 14 longitudinal axis. When the rod is in a first position, as best shown in FIG. 1B, the rod proximal end 32 may be coupled to the sheath near the sheath proximal end 42. When the rod is in a second position, as best shown in FIG. 1A, the rod proximal end may be coupled to the sheath near the sheath distal end 40.

A portion of the rod 12 may be adapted to slide into and out of the sheath 14. One embodiment, as best shown in FIG. 3, may be comprised of the inner slider 18 which is adapted to allow the rod to slide in and out of the sheath, yet keeping the rod's longitudinal axis substantially parallel with the sheaths' longitudinal axis. A cut-away of the sheath and inner slider, showing how the rod may be coupled to the slider, is shown in FIG. 3.

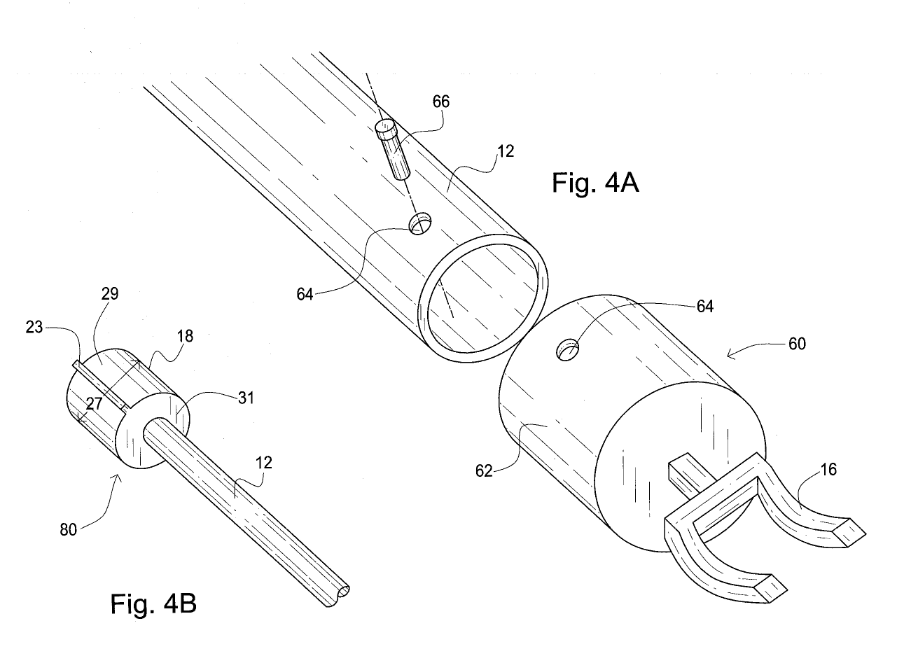

As best shown in FIG. 4B, the slider 18 may also be comprised of an alignment portion 23. The alignment portion may be adapted to prevent the slider from rotating in the sheath 14. One alignment portion may be a flange. The flange may be adapted to fit within, and be received by, a notch in the inside of the sheath, similar to a key and a key way. Whatever the alignment portion design, or even in embodiments not having an alignment portion, when the rod is changed from a first position, as best shown in FIG. 1B to the second position, as best shown in FIG. 1A, a stabilization device may need to be implemented to secure the rod in the correct position.

The slider 18 may be comprised of a hollow tube 29 with washers 31 coupled or integrated to each tube end. The rod 12 may then be coupled to or integrated to the washers in order to secure the rod to the slider. In one embodiment the rod is welded to the washers. Also in an embodiment, the slider and may be comprised of stainless steel. The sheath may be comprised of a composite or a polymeric material. One such material that may be used for the sheath is fiberglass. Other materials are also contemplated.

In one embodiment, the rod 12 is substantially stationary relative to the sheath 14 when the rod is in both the first and second positions. The rod may be stationary relative to the sheath by coupling to the sheath through a stabilization device. One stabilization device may be comprised of a slider or a rod having a ball-spring mechanism adapted to couple to a sheath bore 44. One embodiment's sheath may have two bores, with one bore located near the sheath proximal end 42 and one located near the sheath distal end 40.

When the rod 12 is in the first position, a slider ball or a rod ball may be substantially aligned with the sheath distal end bore 44. A spring may then extend a portion of the ball into the bore, keeping the rod and slider 18 substantially immobile relative to the sheath 14. Other stabilizations devices such as, but not limited to, pins, may also be used. To move the rod between the first and second positions, the stabilization device is uncoupled from the sheath. For example, after the ball is inserted into a bore, the ball may need be depressed inwardly to compress the spring. When the ball is pressed out of the bore and into the slider or rod, the rod may be slid between positions and subsequently aligned with a new sheath bore to lock the rod in a new position.

The tolerance between the inner diameter 25 (shown in FIG. 3) of the sheath 14 and the slider outer diameter 27 (shown in FIG. 4B) is relatively low, as compared to the diameter sizes themselves. For example, one sheath may have an outer diameter 26 of 1 inch and an inner diameter of ⅞ inches. The slider diameter in such an embodiment may be 13/16 inches. The slider inner diameter 21 (as shown in FIG. 3) may be 11/16 inches in an embodiment. The slider may also have a distal end 80. The rod may extend through the distal end in one embodiment.

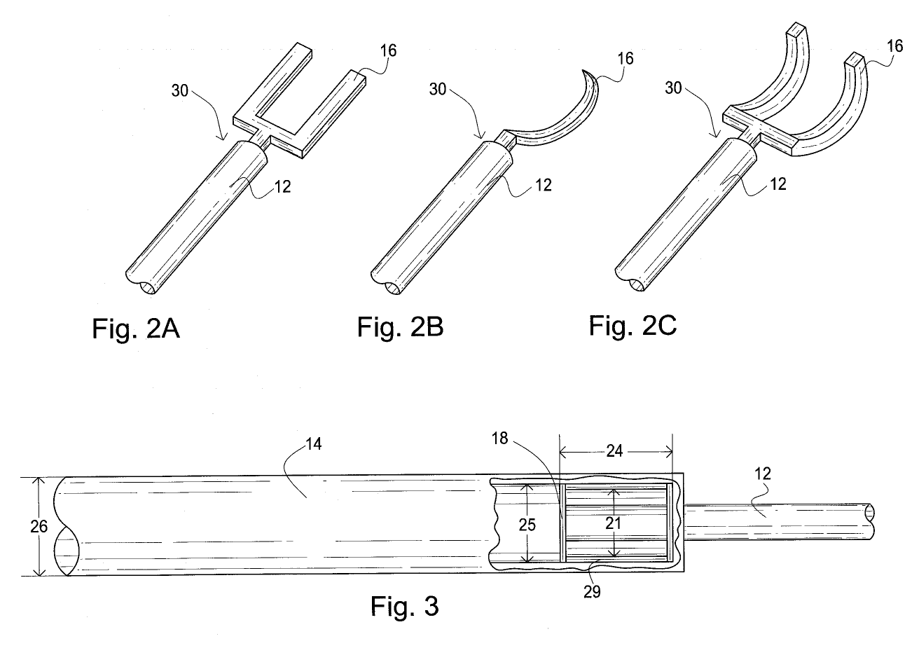

The coupling mechanism 16 in one embodiment is adapted to couple or integrate to a rod 12, with FIGS. 2A-2C showing a series of coupling mechanisms integrated or coupled to the rod. In one embodiment, the coupling mechanism may be screwably coupled to the rod distal end 30. The coupling mechanism may also be welded to the rod. In one embodiment the coupling mechanism and the rod are both comprised of stainless steel. An embodiment may also be comprised of a coupling mechanism 16 coupled to a sheath end such as, but not limited to, a fiberglass broom handle end without a sliding rod, as best shown in FIG. 8, showing a screwably connected coupling mechanism coupled to the sheath distal end 40.

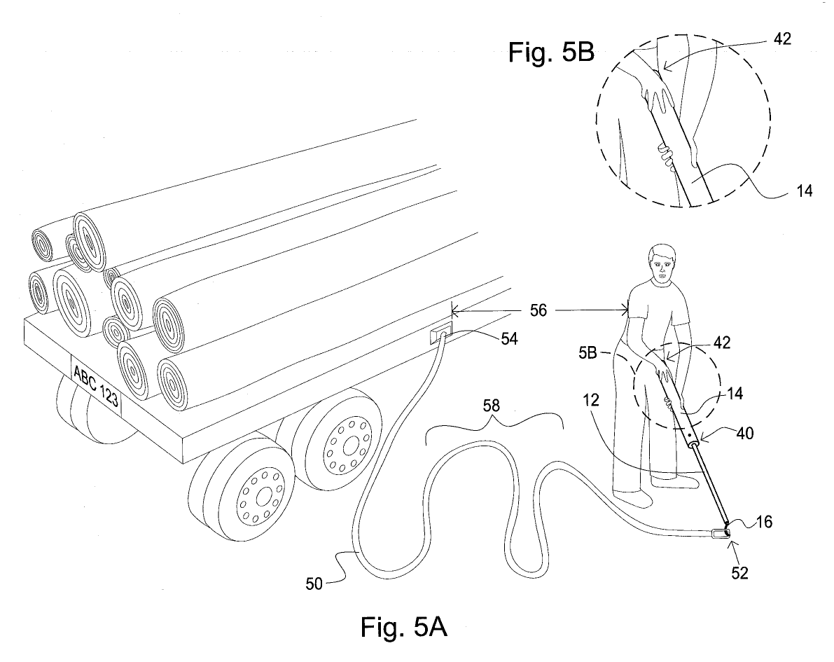

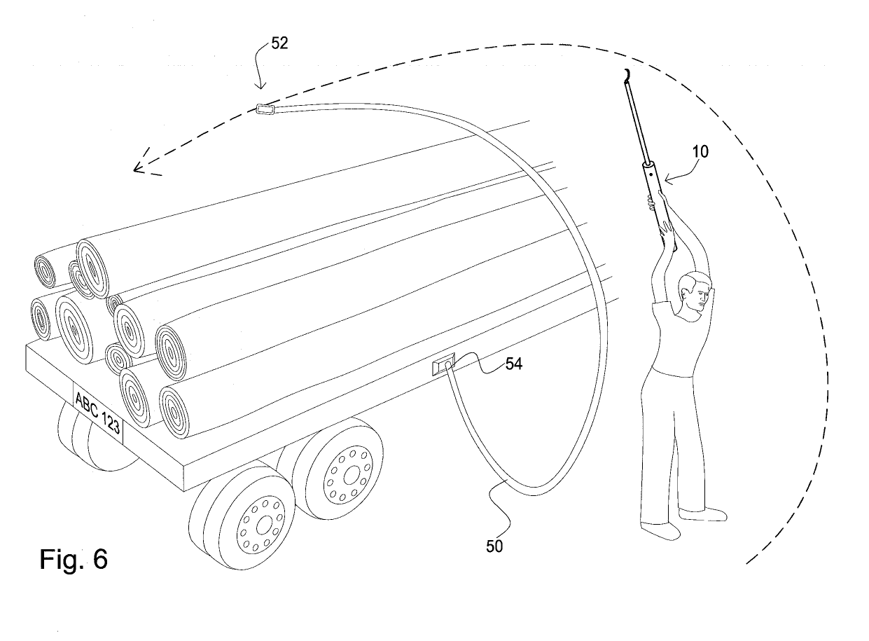

The coupling mechanism 16 may be comprised of a shape adapted to couple and release a specific wrapper design (a wrapper 50 example is shown in FIGS. 5 and 6). The coupling mechanism may enable the wrapper to stay coupled to the cable slinger 10 upon a user picking up the wrapper. In one embodiment, the wrapper is coupled to the coupling mechanism as the user begins a swinging motion with the cable slinger. In one embodiment, at or generally near the apex of the swinging motion, the coupling mechanism is adapted to release the wrapper. The wrapper coupling mechanism 16 may be generally adapted to release the wrapper 50 at an appropriate position in the user's swing for a wrapper end to travel over the loaded logging truck bed and land on an opposing side of the truck. For example, as best shown in FIG. 2A, a coupling mechanism may be adapted to couple to a tether line and release the tether line at about the apex of a person's throwing motion. Similarly, FIGS. 2B and 2C may be adapted to couple to a strap and a cable or chain, respectively. A coupling mechanism embodiment may also require a “jerking” motion to release the wrapper.

Along these lines, in one embodiment, a coupling mechanism 16 may be generally shaped as an oblate ellipsoid. For example, in FIG. 2B, the coupling mechanism may have a radius of curvature having an equatorial (semi-major) radius of about 2 in. and a polar (semi-minor) radius of about 1 in. Similarly, in FIG. 2A, showing a pronged coupling mechanism version, the length of the prongs may be about 4 inches. In FIG. 2C, the coupling mechanism may also be an oblate ellipsoid having a semi-major radius of about 3 inches and a semi-minor radius of about 2 inches, or may even be a generally spherical ellipsoid. The thickness of a coupling mechanism may be about 0.375 inches, and in one embodiment may have a generally variable thickness, generally being thicker than 0.25 inches and less than 1 inch. Depending on the nature, or style of wrapper 50 used, one of these types of coupling mechanisms, or another type of coupling mechanism not shown, may be best suited for the wrapper to slide out of the coupling mechanism at or near an apex of the throwing motion.

Similarly, the arcuate shape of one embodiment may have a generally bow-like design, or even a sickle-like design. The arc in one embodiment preferably extends between 90 & 180 degrees of an ellipsoid or a generally spherical shape, more preferable extends between 110 and 160 degrees, and most preferably extends between 130 and 140 degrees. In prong-shaped coupling mechanisms, as best shown in FIG. 2A, there may be a plurality of prongs, or there may be a single flat prong. However, when there is a plurality of prongs, the prongs may be generally parallely aligned, and spaced apart in a manner adapted to allow a portion of a wrapper to slide between the prongs. In one embodiment, the prongs may be about 1 inch apart, although ½ inch and 2 inch spaced prongs are possible, among other sizes. Each of these type of coupling mechanisms, among other styles not displayed are designed to allow the wrapper to slide off of the coupling mechanism at an appropriate portion of the swing in order for the wrapper to travel over the truck.

As best shown in FIG. 4A, one embodiment may also be comprised of a hook attachment device 60. One hook attachment device may be comprised of the coupling mechanism 16 and a coupled or an integrated cable slinger adapter 62. The adapter may have a bore 64 adapted to align with a bore 64 on a rod 12 or a sheath 14. Through the two bores may be placed a pin 66 to lock the attachment device to the cable slinger 10. The attachment device may allow a user to couple different wrapper coupling mechanism designs to the cable slinger, so a user may use a single cable slinger sheath or rod to throw multiple wrapper versions such as, but not limited to, cables, chains and straps. The attachment device may couple to the rod or sheath in a manner different than the pin-bore combination shown in FIG. 4A. FIG. 8 shows a nylon strap coupling mechanism screwably coupled to the attachment device.

### One Method of a Slinging a Cable:

As best shown in FIGS. 5 through 7, one method of throwing a wrapper 50 includes using a cable slinger 10. One cable slinger is comprised of a wrapper coupling mechanism 16 and a sheath 14. The coupling mechanism may be operatively coupled to a sheath end. In one method, a cable slinger is used which may have a coupling mechanism operatively coupled to a sheath distal end 40. One method may also be comprised of a cable slinger having a rod 12. The coupling mechanism may be coupled to the rod. In one method, a user picks up the cable slinger and subsequently couples a wrapper 50 to the coupling mechanism. Additionally method may include unlocking the rod from a retracted position (as best shown in FIG. 1B) and locking the rod in an extended position (as best shown in FIG. 1A).

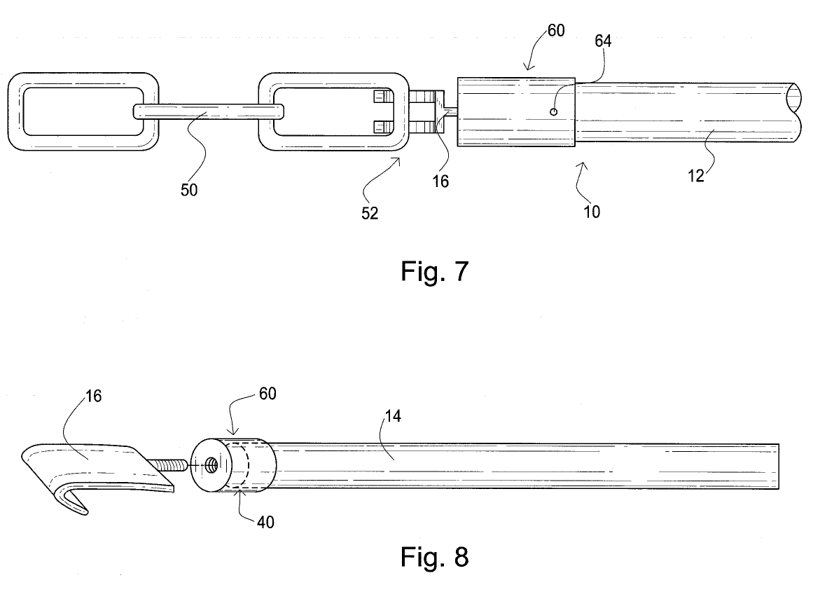

In one method, the manner in which the wrapper 50 is coupled to the coupling mechanism is dependent upon the type of coupling mechanism which is employed. One method may use a coupling mechanism 16 such as, but not limited to, a dual-hook device as best shown in FIG. 7, which may be adapted to couple to a chain. As best shown in FIGS. 5 and 6, one wrapper 50 may be a strap. Strap coupling mechanisms may not be dual-hook devices. In one method, the type of coupling mechanism employed is dependent not only upon the type of wrapper used (chain, strap, etc.), but also on the weight of the wrapper, the distance & height the wrapper needs to travel, and what may be coupled to the end of the wrapper. For example, a buckle may be coupled to the end of a strap. In such an embodiment, a different coupling mechanism may be used than is used if a hook is coupled to the end of a strap.

In one method, the user couples the cable slinger to a wrapper proximal end 52. In another method, before the user couples the cable slinger 10 to the wrapper 50, a wrapper distal end 54 may be coupled to a first location. One first location, as best shown in FIG. 5, is a position on a side of a logging truck bed.

In one method, the user may grip the sheath 14 of the cable slinger 10. A user may grip the sheath proximal to an end of the sheath such as a sheath proximal end 42. The sheath may have a hand grip to help a user hold onto the device. The sheath may also be wrapped in a material such as, but not limited to leather, or coated with a material in order to provide a better gripping surface. The end of the sheath that the user grips may be an end opposing the end of the sheath that the coupling mechanism 16 is operatively coupled to, possibly through a rod 12. In one method, the user may hold the sheath proximal end with outstretched arms and in a downward fashion, as best shown in FIG. 5, with a coupling mechanism and coupled wrapper coupled to an opposing slinger end.

One method may include an embodiment comprised of an attachment device 60 (as best shown in FIG. 4A). Such a method may include coupling the attachment device to a rod 12 or a sheath 14 before coupling the wrapper to the coupling mechanism. A step may include aligning a bore 64 on the adapter 62 with a bore on the rod or sheath. The method may also include placing a pin through the bores. Other attachment device coupling methods are also contemplated.

When the user is holding the cable slinger 10 with an end of the wrapper 50 coupled to the coupling mechanism 16, in one method the user places himself or herself in the first position. The first position may be relative to the first location of the wrapper distal end 54. In one method the first position for a user is a distance 56 of about 10 feet from the first location, with both the first position and first location being located on a truck first side.

A method may also include the user facing substantially away from the first location of the wrapper distal end 54, placing his or her back towards the first location so that the user's back is generally parallel with the truck first side. In one such method, when a user faces away from the first position, as the wrapper extends away from the wrapper proximal end 52, the wrapper may rest on the ground at a user's side, as best shown in FIG. 5. In one method it is a wrapper middle portion 58 that rests to a user's side. Other methods may include a user who does not stand the 10 foot distance away from the first location or who does not face away from the first position in a manner where the user's back is generally parallel with the truck side.

In one method a user may hold the cable slinger 10 in a generally downward angle with a cable slinger coupling mechanism 16 and coupled wrapper 50 generally located near a user's feet, as best shown in FIG. 5. The cable slinger is then brought to a generally overhead position in one method, as best shown in FIG. 6. The motion used may be a throwing motion or may be generally similar to an arcing casting motion.

Depending on the type of wrapper 50 being used (such as a cable, chain, etc.), a specific type of coupling mechanism 16 may be used during the method. One type of coupling mechanism may be adapted to release the wrapper when the wrapper coupling mechanism and coupled wrapper proximal end 52 is near the apex of the user's overhead swing. For example, one method may use a coupling mechanism with an oblate ellipsoid shape having a semi-major axis preferably of about 3 inches, more preferable of about 2.5 inches, and most preferably of about 2 inches and a semi-minor axis preferably of about 1.5 inches, more preferably of about 1.25 inches, and most preferable of about 1 inch. Such a coupling mechanism may be used with a wrapper such as a chain wherein, as the slinger reaches a location in the swing near the apex, the chain link coupled to the coupling mechanism begins to slide towards the truck. A correct radius of curvature, or other coupling mechanism design, for a particular type of wrapper may enable the wrapper to be released at the point in the slinger swing with a strong possibility for the wrapper to travel over the logging load. Other methods may include jerking the cable slinger in an opposing direction than the casting motion to release the wrapper.

When the wrapper proximal end 52 is released from the coupling mechanism 16, in one method the wrapper 50 travels in direction generally towards and over a logging truck load. At a point after the wrapper proximal end reaches the mid-way point of the logging load, the proximal end may begin to travel in a generally downward direction towards the other side of the truck. In one method, the wrapper proximal end may land on a side of a logging truck opposing the side of the logging truck where the first position is located. Upon landing on an opposing side of a logging truck, in one method, the wrapper is tightened about the logging load. The proximal end may be coupled to the logging truck. Generally, the wrapper may travel from a first wrapper location to a second wrapper location—a logging truck need not be involved.

It should be noted that in one method, a user may grip of the cable slinger with an opposing-hand grip, as best shown in FIG. 5B. In one opposing-hand grip method the palm of one hand generally faces in a downward direction and the palm of the user's other hand generally faces in the up direction. In one method, the hand located near the sheath proximal end 42 is the hand with the palm facing downward and the hand located nearest the sheath distal end 40 is the hand with the palm facing generally upward. With such a grip a user may sling the cable over the truck by pressing down on the hand near the sheath proximal end while simultaneously or near simultaneously pulling up with the hand facing upward. With such a motion, the coupling mechanism 16 travels towards the truck at a high rate of speed, sending the wrapper proximal end 52 towards and over the truck. This is one way that a cable slinger may help to decrease the chance that a logger or a logging truck driver will be injured through wrapping a logging truck. When using this, or another similar, method, the energy it takes to toss the wrapper over the truck is decreased as compared to not using the cable slinger.

### Other Embodiments and Variations

The embodiments of the rotating step stool as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure.

I claim:

1) A device comprising,
a sheath having a sheath proximal end and a sheath distal end; and
a wrapper coupling mechanism adapted to (i) couple to a wrapper, and (ii) release
a wrapper upon performing a casting motion with the device.

2) The device of claim 1 further comprising,
a rod having a rod distal end and a rod proximal end;
a slider; and
wherein,
the sheath covers at least a portion of the rod; and
the wrapper coupling mechanism is comprised of a hook coupled to the rod distal end, the hook generally comprising (i) an arc not greater than 180 degrees, and (ii) a semi-major axis radius length at least equal to the semi-minor radius axis length.

3) The device of claim 1 further comprising,
a rod having a rod distal end and a rod proximal end;
a slider; and
wherein,
the coupling mechanism is comprised of a plurality of prongs;
the rod and slider are operatively slidably coupled to the sheath.

4) The device of claim 3 wherein,
the rod proximal end lockably couples to the sheath at a first position and a second position; and
the plurality of prongs are two generally parallel prongs having (i) a longitudinal axis generally aligned with a rod and a sheath longitudinal axis and (ii) at least one flat surface.

5) The device of claim 4 wherein,
the slider (i) operatively coupling to the rod, and (ii) having at least a portion enclosed by the sheath;
the first position comprising a location proximate the sheath proximal end; and
the second position comprising a location proximate the sheath distal end.

6) The device of claim 2 wherein, the semi-major axis radius is at least twice as long as the semi-minor axis.

7) The device of claim 1 wherein,
the sheath is comprised of a fiberglass broom handle; and
the coupling mechanism is screwably operatively coupled to the broom handle.

8) The device of claim 2 wherein,
the sheath is coupled to the rod proximal end and is about 2.5 feet long;
the rod is about 3 feet long and extends through a slider distal end; and
the slider is about 6 inches long.

9) A method of throwing a wrapper comprising,
holding a cable slinger comprising (i) a sheath having a proximal end and a distal end, and (ii) a coupling mechanism adapted to couple to and subsequently release a wrapper during a throwing motion;
coupling a wrapper having a proximal end and a distal end to the coupling mechanism;
swinging the sheath distal end in a generally arcing motion; and
releasing the wrapper from the coupling mechanism, allowing the wrapper proximal end to travel away from the wrapper distal end.

10) The method of claim 9 wherein,
the cable slinger is further comprised of a rod;
said releasing the wrapper from the coupling mechanism includes release of the wrapper generally at an apex of the arcing motion; and
further comprising extending at least a portion of the rod out of the sheath.

11) The method of claim 9 wherein, said swinging the sheath distal end in a generally arcing motion includes moving the sheath in a casting motion generally towards a truck first side.

12) The method of claim 9 further including:
unlocking the rod from a first position; and
locking the rod section in a second position.

13) The method of claim 9 wherein,
said holding a cable slinger includes using two hands generally opposing one another; and
said coupling a wrapper to a coupling mechanism includes hooking the wrapper.

14) The method of claim 11 wherein, said casting motion includes:
facing away from the truck first side;
moving the wrapper proximal end over one's head; and
jerking the cable slinger in a direction generally opposing the arcing direction.

15) The method of claim 9 further including,
coupling an attachment device to the cable slinger;
aligning a bore on the attachment device with a bore on one of the rod and sheath; and
placing a pin through at least one of the bore on one of the rod and sheath.

16) A logging cable combination comprising:
a cable slinger comprising
a sheath having a sheath proximal end and a sheath distal end,
a wrapper coupling mechanism,
(i) comprising at least one hook prong having an arc, the arc having between a 0 degree and a 180 degree arc,
(ii) further comprising a longitudinal axis generally aligned with a sheath longitudinal axis, and
(iii) adapted to couple to a wrapper and subsequently release the wrapper upon performing a throwing motion with the slinger; and
a wrapper.

17) The combination of claim 16 further including:
a logging truck; and
a logging load.

18) The combination of claim 16 wherein,
the wrapper coupling mechanism is a hook; and
the wrapper is a cable.

19) The combination of claim 17 wherein, the coupling mechanism (i) generally resembles one of a bow and a sickle, and (ii) is further adapted to enable the wrapper to slide off the coupling mechanism during an arcing throwing motion over a user's head, a wrapper portion traveling over the logging load.

20) The combination of claim 19 wherein,
the logging truck is comprised of a full load; and
the cable slinger is further comprised of a rod and slider.
